(19) United States
(12) Patent Application Publication
(10) Pub. No.: US 2009/0046997 A1
(43) Pub. Date: Feb. 19, 2009

(54) APPARATUS AND METHOD OF RECORDING CONTENT

(75) Inventors: Yong-jun Park, Seoul (KR); Hee-soo Lee, Suwon-si (KR); Byung-soo Kim, Seoul (KR); Jae-cheol Lee, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/020,648

(22) Filed: Jan. 28, 2008

(30) Foreign Application Priority Data
Aug. 13, 2007 (KR) 2007-81443

(51) Int. Cl. H04N 7/26

(52) U.S. Cl. 386/124

(57) ABSTRACT

An apparatus and method of recording content includes a user selecting an apparatus to reproduce content, which is to reproduce recorded content, from among at least one apparatus to reproduce content, comparing configuration information of an apparatus to record content and configuration information of the selected apparatus to reproduce content, setting an encoding method to record content, and recording the content according to the set encoding method.

### CROSS-REFERENCE TO RELATED APPLICATIONS

This application claims priority under 35 U.S.C. §119(a) from Korean Patent Application No. 10-2007-0081443, filed on Aug. 13, 2007, in the Korean Intellectual Property Office, the disclosure of which is incorporated herein in its entirety by reference.

### BACKGROUND OF THE INVENTION

1. Field of the Invention

The present general inventive concept relates to an apparatus to record content, and more particularly, to an apparatus and method of automatically setting configuration information of an apparatus to record content by considering configuration information of an apparatus to reproduce content while recording content.

2. Description of the Related Art

Apparatuses for recording/reproducing audio/video (A/V) content, which have been limited to conventional radios or televisions, are expanding to various types of electronics, such as computers, digital televisions, MP3 players, PDAs, PMPs, and DMB receptors, as a digital technology develops. Also, various A/V content, such as movies, music, digital broadcasting programs, and games, are unlimitedly provided through an Internet. Accordingly, encoding/decoding methods suitable to each apparatus for recording/reproducing A/V content or types of content are being continuously developed.

However, while recording content, a conventional apparatus for recording content unilaterally determines an encoding/decoding method without considering system information (including an encoding/decoding method) of an apparatus for reproducing the recorded content. Accordingly, the apparatus for reproducing the recorded content occasionally does not support the encoding/decoding method of the recorded content, and thus reproducing the recorded content is not possible, or the quality of the reproduced content deteriorates.

Moreover, even when a user can select and set one of encoding/decoding methods while recording content, the user has to remember system information of all apparatuses for reproducing the content that the user uses.

### SUMMARY OF THE INVENTION

The present general inventive concept provides a method and apparatus to set configuration information most suitable to an apparatus to record content by considering system information of an apparatus to reproduce content recorded by the apparatus to record content.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an apparatus to set configuration information of an apparatus to reproduce content, the apparatus including a configuration information storage unit to store configuration information of at least one apparatus to reproduce content, and a configuration information manager, to set the configuration information of the apparatus to record the content by referring to the configuration information of the apparatus to reproduce the content stored in the configuration information storage unit.

The foregoing and/or other aspects and utilities of the general inventive concept may also be achieved by providing a method of updating a system file of a portable storage medium, the method including connecting the portable storage medium to an apparatus to reproduce content, determining whether the system file of the portable storage medium contains a same system information as system information of the apparatus to reproduce the content, and updating the system file of the portable storage medium.

The foregoing and/or other aspects and utilities of the general inventive concept may also be achieved by providing a method of updating configuration information of an apparatus to reproduce content, the method including comparing first configuration information of an apparatus to reproduce content obtained from an external apparatus and second configuration information of an apparatus to reproduce the content stored in an apparatus to record the content, when the first configuration information and the second configuration information are different, updating the second configuration information by referring to the first configuration information.

The foregoing and/or other aspects and utilities of the general inventive concept may also be achieved by providing a method of recording content, the method including comparing configuration information of an apparatus to record content and configuration information of a selected apparatus to reproduce the content, setting an encoding method to record the content, and recording the content according to the set encoding method.

The foregoing and/or other aspects and utilities of the general inventive concept may also be achieved by providing an apparatus to set configuration information of an apparatus to reproduce content, the apparatus including a configuration information storage unit to store configuration information of at least one apparatus to reproduce content, and a configuration information comparator to compare the stored configuration information of the apparatus and new configuration information of the apparatus to reproduce the content, and to update the stored configuration information with the new configuration information.

The foregoing and/or other aspects and utilities of the general inventive concept may also be achieved by providing an apparatus to set configuration information of an apparatus to reproduce content, the apparatus including a configuration information storage unit to store configuration information of an apparatus to reproduce content, a configuration information comparator to update the stored configuration information of the apparatus with new configuration information of the apparatus and a configuration information manager to record the content and at least one of the configuration information and the new configuration information in a portable storage medium.

The foregoing and/or other aspects and utilities of the general inventive concept may also be achieved by providing a method of setting configuration information of an apparatus to reproduce content, the method including storing configuration information of an apparatus to reproduce the content, and setting the configuration information and recording the content and the configuration information corresponding to the content.

The foregoing and/or other aspects and utilities of the general inventive concept may also be achieved by providing a method of setting configuration information of an apparatus, the method including storing configuration information of an apparatus to reproduce content, updating the stored configuration information with new configuration information, and recording the content and at least one of the configuration information and the new configuration information.

The foregoing and/or other aspects and utilities of the general inventive concept may also be achieved by providing a configuration setting apparatus including one or more of an automatic setting mode and a manual setting mode to set an encoding method to encode content, and a configuration information unit to set a first configuration information of a recording apparatus to record the content corresponding to a second configuration information of a reproducing apparatus to reproduce the content, wherein the reproducing apparatus supports the encoding method of the recorded content.

The foregoing and/or other aspects and utilities of the general inventive concept may also be achieved by providing a method of operating a configuration setting apparatus, the method including selecting one of an automatic setting mode and a manual setting mode to set an encoding method to encode content, and setting a first configuration information of a recording apparatus to record the content corresponding to a second configuration information of a reproducing apparatus to reproduce the content so that the reproducing apparatus supports the encoding method of the recorded content.

The foregoing and/or other aspects and utilities of the general inventive concept may also be achieved by providing a computer-readable recording medium having embodied thereon a computer program to execute a method, wherein the method includes selecting one of an automatic setting mode and a manual setting mode to set an encoding method to encode content, and setting a first configuration information of a recording apparatus to record the content corresponding to a second configuration information of a reproducing apparatus to reproduce the content so that the reproducing apparatus supports the encoding method of the recorded content.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating an apparatus to reproduce audio/video (A/V) content and a portable storage medium according to an embodiment of the present general inventive concept;

FIG. 2 is a diagram illustrating a system to update configuration information of an apparatus to record A/V content according to an embodiment of the present general inventive concept;

FIG. 3 is a block diagram illustrating a structure of an apparatus to record A/V content according to an embodiment of the present general inventive concept;

FIG. 4 is a flowchart illustrating a method of updating a system file of a portable storage medium according to an embodiment of the present general inventive concept;

FIG. 5 is a flowchart illustrating a method of updating configuration information of an apparatus to record A/V content according to an embodiment of the present general inventive concept;

FIG. 6 is a flowchart illustrating a method of recording A/V content according to an embodiment of the present general inventive concept; and

FIG. 7 is a flowchart illustrating a method of recording A/V content according to another embodiment of the present general inventive concept.

FIGS. 8A and 8B are diagrams illustrating an exemplary user interface illustrating a window to select an apparatus to reproduce content and a window to set a content encoding method according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

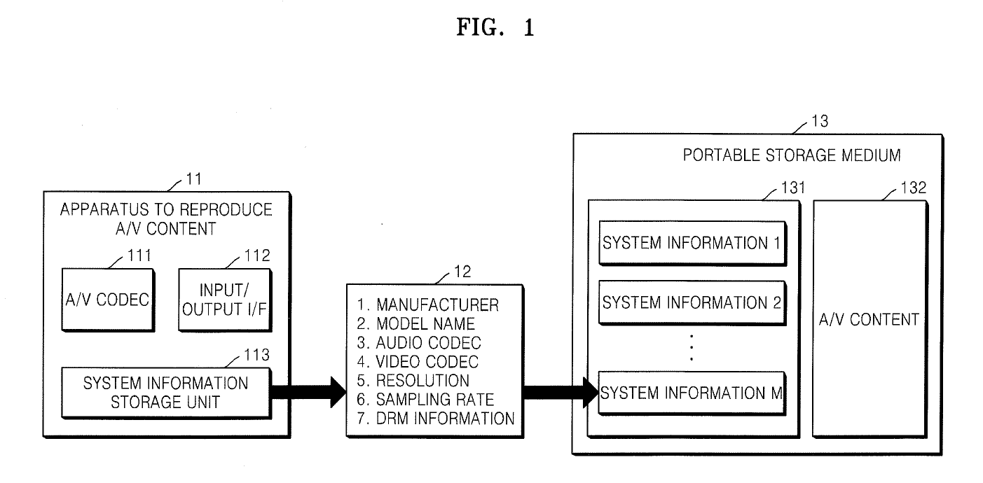

FIG. 1 is a block diagram illustrating an apparatus 11 to reproduce audio/video (A/V) content and a portable storage medium 13 according to an embodiment of the present general inventive concept.

Examples of the portable storage medium 13 include a CD, a DVD, a Blu-ray Disk (BD), an HDD, a micro drive, an USB memory, a secure digital card, a MultiMedia card, a compact flash, and an eXtreme disk. The portable storage medium 13 not only includes a space 132 to store A/V content, but also separately includes a space 131 to store system information of various apparatuses 11 (hereinafter, referred to as a reproducer).

Generally, a size of data of system information of one reproducer 11 is smaller than 1 Kbyte. Accordingly, the space 131 to store system information (or system files) is considerably smaller than the space 132 to store A/V content.

System information 12 of the reproducer 11 is information related to detailed functions and specifications of the reproducer 11. Examples of the system information 12 includes a manufacturer of the reproducer 11, a model name of the reproducer 11, an audio codec, a video codec, resolution, a sampling rate, and digital rights management (DRM) information.

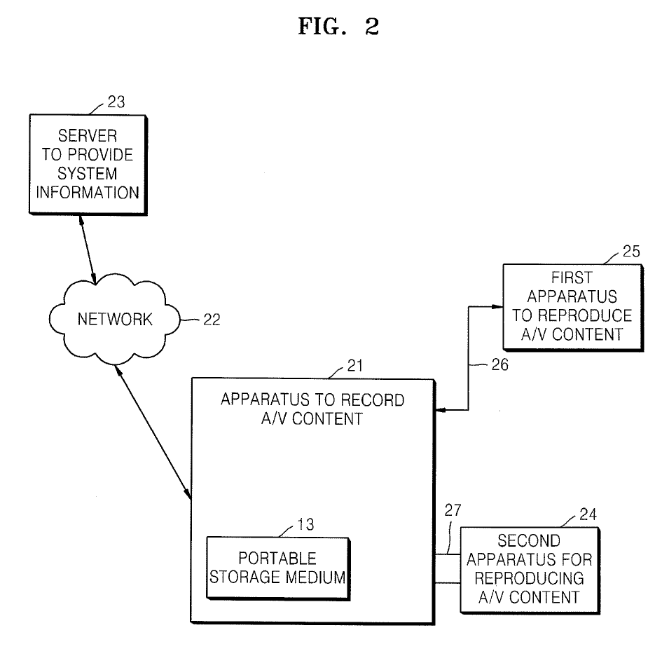

FIG. 2 is a diagram illustrating a system to update configuration information of an apparatus 21 to record A/V content according to an embodiment of the present general inventive concept. FIG. 2 will be described in detail later.

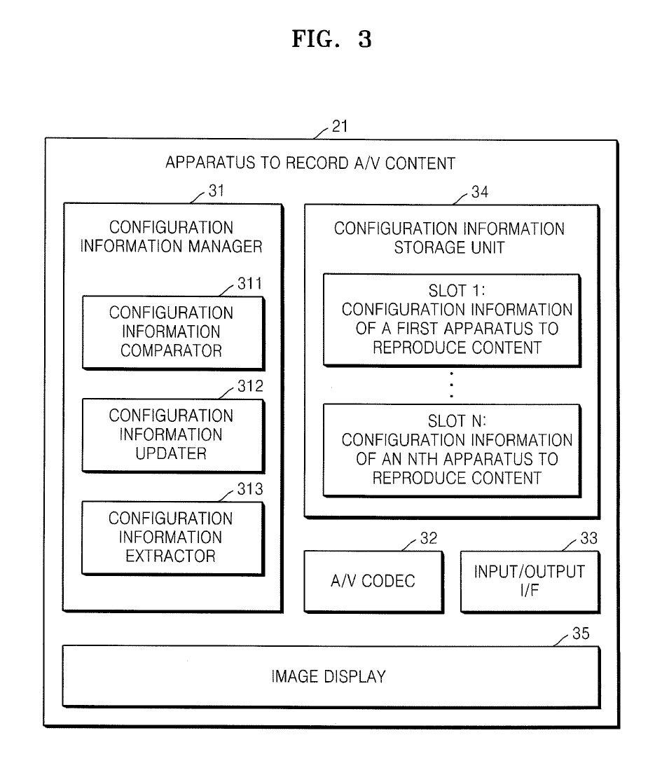

FIG. 3 is a block diagram illustrating a structure of an apparatus 21 to record A/V content according to an embodiment of the present general inventive concept.

Referring to FIGS. 2 and 3, the apparatus 21 (hereinafter, referred to as a recorder) according to the current embodiment includes a configuration information manager 31, an A/V codec 32, an input/output interface 33, a configuration storage unit 34, an image display 35, and a user interface (not illustrated).

The A/V codec 32 is a common designation for an encoder, to encode A/V content that is to be recorded, and a decoder, to decode A/V content.

The configuration information storage unit 34 includes at least one slot, and each slot stores configuration information 1 through N of first through Nth reproducers 11. Here, the configuration information of a reproducer 11 contains a portion of or the entire system information of the reproducer 11. Specifically, the configuration information of the reproducer 11 may include information about an encoding/decoding method of content of the reproducer 11. Accordingly, each slot of the configuration information storage unit 34 includes a portion of or the entire system information of a specific reproducer 11.

The input/output interface 33 controls data communication between a recorder and an external apparatus, such as between a server 23 to provide system information and a first apparatus 25 to reproduce A/V content.

The configuration information manager 31 includes a configuration information comparator 311, a configuration information updater 312, and a configuration information extractor 313.

When a user requests to record A/V content, the configuration information comparator 311 compares the configuration information of the recorder 21 and the configuration information of the selected reproducer 11 in order to determine an optimum encoding/decoding method of the A/V content that is to be recorded.

The configuration information updater 311 determines whether the configuration information 1 through N stored in the configuration information storage unit 34 are required to be updated, and when the update is required, processes of updating configuration information are performed.

The configuration information extractor 313 extracts configuration information of the reproducer 11 from the configuration information storage unit 34.

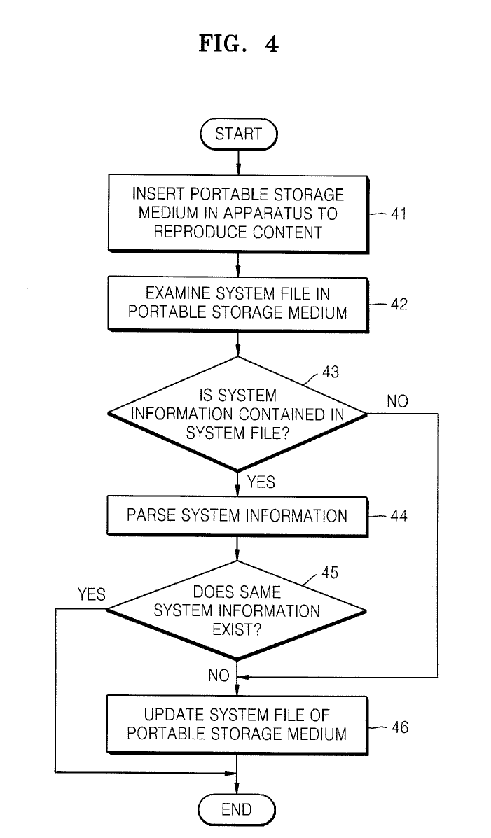

FIG. 4 is a flowchart illustrating a method of updating a system file of a portable storage medium according to an embodiment of the present general inventive concept. The method will now be described with reference to FIGS. 1 and 4.

When the portable storage medium 13 is inserted or connected to the reproducer 11 in operation 41, the reproducer 11 automatically examines a system file in the space 131 of the portable storage medium 13 in operation 42 in order to determine whether the system file contains system information of at least one reproducer 11 in operation 43.

When the system file is determined not to contain the system information in operation 43, operations 44 and 45 are skipped and operation 46 is performed.

Alternatively, when the system file is determined to contain the system information of at least one reproducer 11 in operation 43, the system information is parsed in operation 44.

In operation 45, the reproducer 11 compares the system information stored in the system information storage unit 113 and the system information parsed in operation 44 in order to determine whether the system information are the same.

When the system information in the system information storage unit 113 is determined to be the same as one of the system information included in the system file in the space 131 of the portable storage medium 13 in operation 45, the system file is not required to be updated, and thus the method ends.

However, when the system information in the system information storage unit 113 is not determined to be the same as one of the system information included in the system file in the space 131 of the portable storage medium 13 in operation 45, the reproducer 11 adds the system information in the system information storage unit 113 in the system file of the portable storage medium 13 or changes the existing system information in operation 46.

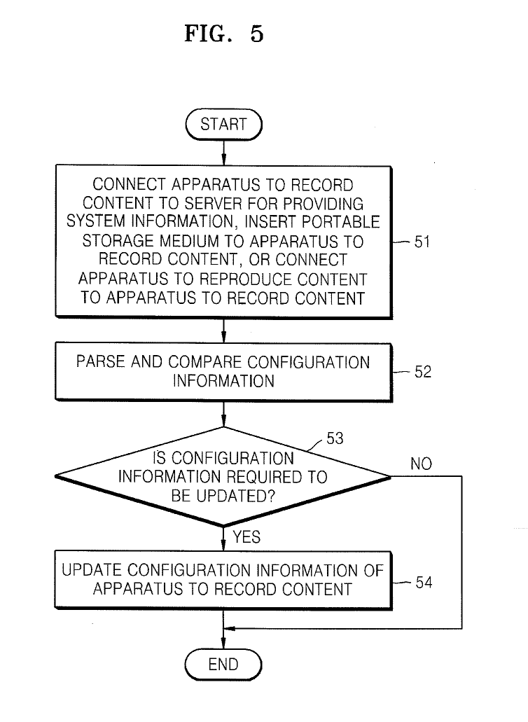

FIG. 5 is a flowchart illustrating a method of updating configuration information of the recorder 21 according to an embodiment of the present general inventive concept. The method of FIG. 5 will now be described with reference to FIGS. 2 and 3.

The server 23 to provide system information is connected to the recorder 21, a first or second apparatus to reproduce A/V content 24 or 25 is connected to the recorder 21, or the portable storage medium 13 is inserted to the recorder 21 in operation 51.

The recorder 21 includes the configuration information storage unit 34, to store configuration information 1 through N of first through N reproducers 11, to record A/V content that is to be recorded, and the configuration information 1 through N stored in the configuration information storage unit 34 should be continuously updated. Accordingly, in order to update the 1 through N configuration information, new configuration information should be obtained from various external apparatuses by the recorder 21 connecting to the external apparatuses.

Examples of the external apparatus include the server 23, the portable storage medium 13, and first and second reproducers 24 and 25. An example of the server 23 may be an IP portal server operated by a manufacturer of the recorder 21 or the reproducer 11. A user can download necessary system information of a reproducer 11 by connecting to the server 23 through a wired/wireless network 22.

The recorder 21 can copy system information, which is not stored in the recorder 21, in the configuration information storage unit 34 by examining the system file of the portable storage medium 13 inserted to the recorder 21.

Also, the recorder 21 may directly obtain system information of the first and second reproducers 24 and 25 respectively from the first and second reproducers 24 and 25. Here, the reproducer 11 may be connected to the recorder 21 according to a specific connector 27 provided by the manufacturer of the reproducer 11, or directly connected through a standardized wired/wireless interface 26. Examples of a wired interface include HDMI, IEEE1394, a parallel port, and a serial port, and examples of a wireless interface include infrared communication, WiFi, and Bluetooth.

In operation 52, a portion of the system information or the entire system information (i.e. the configuration information) obtained from the external apparatus is parsed, and then compared with the configuration information 1 through N stored in the configuration information storage unit 34.

Based on a result of the comparison in operation 52, whether the configuration information of the recorder 21 is required to be updated is determined in operation 53. For example, when the configuration information storage unit 34 of the recorder 21 does not include the configuration information of the second reproducer 24 or even though the configuration information storage unit 34 includes the configuration information of the second reproducer but the detailed content is different and thus needs to be changed, the configuration information of the recorder 21 is required to be updated is determined in operation 53.

In operation 54, the configuration information updater 312 of the recorder 21 updates the configuration information of the recorder 21. If configuration information of a new reproducer needs to be added in the configuration information storage unit 34, a slot, which is empty from among a slot 1 through a slot N in the configuration information storage unit 34, is selected, and the configuration information of the new reproducer is stored in the selected slot. Alternatively, when the existing configuration information should be changed, configuration information in the corresponding slot is changed by referring to the configuration information obtained from the external apparatus.

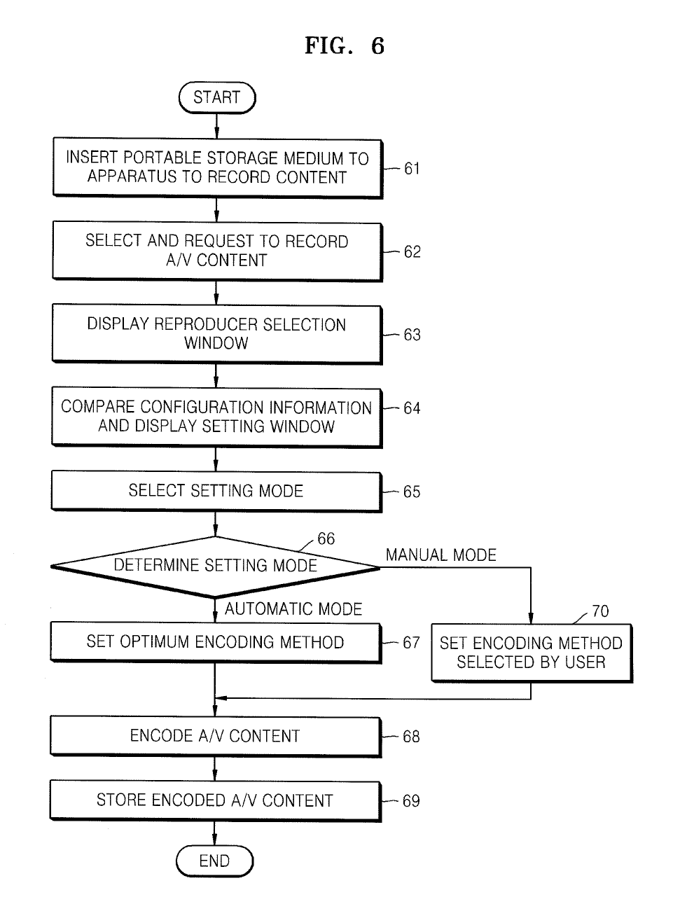

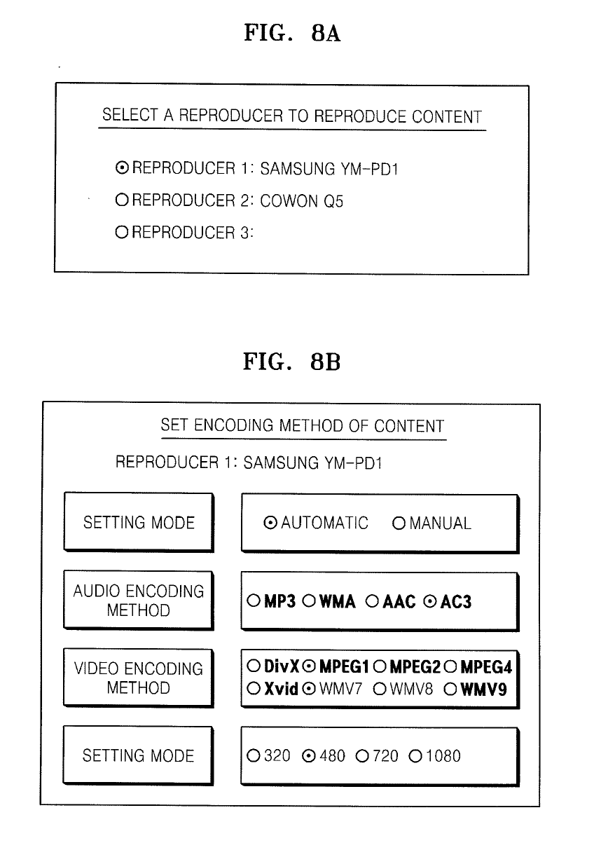

FIG. 6 is a flowchart illustrating a method of recording A/V content according to an embodiment of the present general inventive concept. The method will be described with reference to FIGS. 3 and 8.

In operation 61, a user inserts or connects a portable storage medium, to store A/V content, to the recorder 21.

In operation 62, the user selects A/V content that is to be recorded through a user interface (not illustrated) of the recorder 21, and then starts to record the A/V content.

Then, the user selects a reproducer that will reproduce A/V content that is to be recorded. In order to help the user to select a reproducer, the recorder 21 displays a reproducer selection window illustrated in FIG. 8A on the image display 35 in operation 63. For convenience of explanation, it is assumed that the user selects the first reproducer 25.

When the user selects the first reproducer 25, the configuration information extractor 313 of the recorder 21 extracts the configuration information of the first reproducer 25 from the slot 1 of the configuration information storage unit 34.

The configuration information comparator 311 compares the extracted configuration information of the first reproducer 25 and the configuration information of the recorder 21. For convenience of explanation, the configuration information of the recorder 21 and the first reproducer 25 is illustrated below.

Configuration Information of Recorder

1. Manufacturer: SAMSUNG

2. Model Name: NMS2346

3. Audio Codec: MP3, WMA, AAC, AC3

4. Video Codec: DivX, MPEG1, MPEG2, MPEG4, XviD, WMV7, WMV8, WMV9

5. Resolution: 320, 480, 720, 1080

6. Sampling Rate:

7. DRM Information:

Configuration Information of First Reproducer

1. Manufacturer: SAMSUNG

2. Model Name: YM-PD1

3. Audio Codec: MP3, WMA, AC3, AAC

4. Video Codec: DivX, MPEG1, MPEG2, MPEG4, XviD, WMV9

5. Resolution: 480*272(WQVGA)

6. Sample Rate: ˜48 KHz, ˜192 Kbps

7. DRM Information:

In operation 64, the configuration information comparator 311 compares the configuration information, specifically information related to encoding/decoding the A/V content, such as an audio codec, a video codec, and resolution. Based on the result of comparison, the recorder 21 displays a setting window illustrated in FIG. 8(b) to help the user to set an encoding/decoding method of the A/V content on the image display 35. All encoding/decoding methods supported by the recorder 21 are illustrated on the setting window according to each encoding/decoding item. For example, all video encoding/decoding methods, such as DivX, MPEG1, MPEG2, MPEG4, XviD, WMV7, WMV8, and WMV9, supported by the recorder 21 are illustrated on the setting window in a video encoding/decoding item. Then, from among the all video encoding/decoding methods, only video encoding/decoding methods, such as DivX, MPEG1, MPEG2, MPEG4, XviD, and WMV9, supported by the first reproducer 25 are highlighted and the remaining video encoding/decoding methods are blurred.

In operation 65, the user can select an encoding/decoding method setting mode. As illustrated in FIG. 8(b), the setting window includes an item about a setting mode, besides the encoding/decoding items. Types of the setting mode include a manual mode and an automatic mode.

When the user selected an automatic mode is determined in operation 66, the recorder 21 automatically selects the optimum encoding/decoding method in operation 67. For example, when the user selects the “automatic” as the setting mode in FIG. 8(b), the recorder 21 selects “AC3”, which has the best sound quality from among supported audio encoding/decoding methods, and “480”, which is the highest resolution.

Alternatively, when the user selected a manual mode is determined in operation 66, the user can select a desired encoding/decoding method from the setting window in operation 70.

In operation 68, A/V content, which is selected according to the encoding method set up in operation 67 or 70, is encoded. Then, the encoded A/V content is stored in the portable storage medium in operation 69.

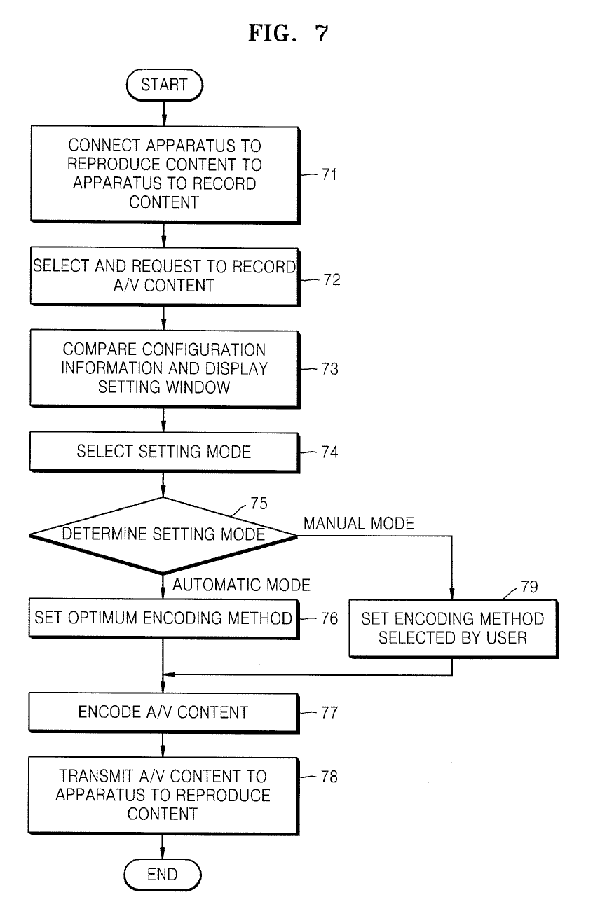

FIG. 7 is a flowchart illustrating a method of recording A/V content according to another embodiment of the present general inventive concept.

The method of FIG. 7 is similar to the method of FIG. 6, but has following differences.

The method of FIG. 6 stores the encoded A/V content in the portable storage medium whereas the method of FIG. 7 stores the encoded A/V content in the reproducer 11. Accordingly, the method of FIG. 7 does not need operation 63 of FIG. 6 since the recorder 21 can identify a connected reproducer 11. Also, in operation 78, the encoded A/V content is transmitted to the connected reproducer 11 through a connector or a wired/wireless interface. The rest operations of FIG. 7 are identical to the corresponding operations of FIG. 6.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

According to the method and apparatus to automatically set configuration information of a recorder, inconvenience of setting configuration information of a recorder by individually checking system information of a reproducer can be reduced, when a user records content using the recorder.

In addition, the recorder provides the user with an optimum A/V reproduction quality by automatically setting the optimum configuration information by considering system information of the reproducer that will reproduce recorded content.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An apparatus to set configuration information of an apparatus to reproduce content, the apparatus comprising:
a configuration information storage unit to store configuration information of at least one apparatus to reproduce the content; and
a configuration information manager to set the configuration information of the apparatus to record the content by referring to the configuration information of the apparatus to reproduce the content stored in the configuration information storage unit.

2. The apparatus of claim 1, wherein the configuration information manager comprises:
a configuration information comparator to compare the configuration information of the apparatus to record the content and the configuration information of the apparatus to reproduce the content.

3. The apparatus of claim 1, wherein the configuration information manager comprises:
a configuration information extractor to extract the configuration information of one apparatus to reproduce the content from the configuration information storage unit.

4. The apparatus of claim 1, wherein the configuration information manager comprises:
a configuration information updater to add or change the configuration information stored in the configuration information storage unit by referring to new configuration information obtained from an external apparatus.

5. The apparatus of claim 4, wherein the external apparatus is one of a server to provide system information, a portable storage medium, and an apparatus to reproduce the content.

6. The apparatus of claim 5, wherein the portable storage medium is one of a CD, a DVD, a Blu-ray disk (BD), an HDD, a micro drive, an USB memory, an SD card, a MultiMedia card (MMC), a compact flash (CF), and an eXtreme disk (XD).

7. The apparatus of claim 1, wherein the configuration information of the apparatus to reproduce the content contains at least one of an audio encoding and decoding method, a video encoding and decoding method, resolution, a sampling rate, and digital rights management (DRM) information.

8. The apparatus of claim 1, wherein the configuration information manager automatically sets an optimum encoding method of content by comparing the configuration information of the apparatus to reproduce the content and the configuration information of the apparatus to record the content.

9. The apparatus of claim 1, wherein the configuration information manager sets an encoding method of content according to an encoding method selected by a user.

10. A method of updating a system file of a portable storage medium, the method comprising:
connecting the portable storage medium to an apparatus to reproduce content;
determining whether the system file of the portable storage medium contains the same system information as system information of the apparatus to reproduce the content; and
updating the system file of the portable storage medium.

11. The method of claim 10, wherein the system information of the apparatus to reproduce the content contains at least one of a manufacturer of the apparatus to reproduce the content, a model name of the apparatus to reproduce the content, an audio encoding and decoding method, a video encoding and decoding method, resolution, a sampling rate, and DRM information.

12. A method of updating configuration information of an apparatus to reproduce the content, the method comprising:
comparing first configuration information of an apparatus to reproduce the content obtained from an external apparatus and second configuration information of an apparatus to reproduce the content stored in an apparatus to record the content;
when the first configuration information and the second configuration information are different, updating the second configuration information by referring to the first configuration information.

13. The method of claim 12, wherein the external apparatus is one of a server to provide system information, a portable storage medium, and an apparatus to reproduce the content.

14. The method of claim 12, wherein the updating of the second configuration information further comprises:
allocating a configuration information slot in a configuration information storage unit; and
storing the second configuration information.

15. A method of recording content, the method comprising:
comparing configuration information of an apparatus to record content and configuration information of a selected apparatus to reproduce the content;
setting an encoding method to record the content; and
recording the content according to the set encoding method.

16. The method of claim 15, further comprising:
a user inserting a portable storage medium, to store configuration information of an apparatus to reproduce the content, to the apparatus to record the content.

17. The method of claim 15, further comprising:
a user selecting an apparatus to reproduce the content, which is to reproduce the content that will be recorded, from among at least one apparatus to reproduce the content.

18. The method of claim 15, further comprising:
a user connecting an apparatus to reproduce the content, which is to reproduce the content that will be recorded, to an apparatus to record the content.

19. The method of claim 15, further comprising:
a user selecting one of an automatic setting mode and a manual setting mode as a mode to set an encoding method.

20. The method of claim 19, wherein when the user selects an automatic setting mode as a mode to set an encoding method, the apparatus to record the content sets the optimum encoding method from among supported encoding methods.

21. An apparatus to set configuration information of an apparatus to reproduce content, the apparatus comprising:
a configuration information storage unit to store configuration information of at least one apparatus to reproduce content; and
a configuration information comparator to compare the stored configuration information of the apparatus and new configuration information of the apparatus to reproduce the content, and to update the stored configuration information with the new configuration information.

22. The apparatus of claim 21, further comprising:
a configuration information manager to store the content and the configuration information in a portable storage medium.

23. An apparatus to set configuration information of an apparatus to reproduce content, the apparatus comprising:
a configuration information storage unit to store configuration information of an apparatus to reproduce content;
a configuration information comparator to update the stored configuration information of the apparatus with new configuration information of the apparatus; and
a configuration information manager to record the content and at least one of the configuration information and the new configuration information in a portable storage medium.

24. A method of setting configuration information of an apparatus to reproduce content, the method comprising;
storing configuration information of an apparatus to reproduce the content; and
setting the configuration information and recording the content and the configuration information corresponding to the content.

25. A method of setting configuration information of an apparatus, the method comprising;
storing configuration information of an apparatus to reproduce content;
updating the stored configuration information with new configuration information; and
recording the content and at least one of the configuration information and the new configuration information.

26. A configuration setting apparatus, comprising:
one or more of an automatic setting mode and a manual setting mode to set an encoding method to encode content; and
a configuration information unit to set a first configuration information of a recording apparatus to record the content corresponding to a second configuration information of a reproducing apparatus to reproduce the content,
wherein the reproducing apparatus supports the encoding method of the recorded content.

27. A method of operating a configuration setting apparatus, the method comprising:
selecting one of an automatic setting mode and a manual setting mode to set an encoding method to encode content; and
setting a first configuration information of a recording apparatus to record the content corresponding to a second configuration information of a reproducing apparatus to reproduce the content so that the reproducing apparatus supports the encoding method of the recorded content.

28. A computer-readable recording medium having embodied thereon a computer program to execute a method, wherein the method comprises:
selecting one of an automatic setting mode and a manual setting mode to set an encoding method to encode content; and
setting a first configuration information of a recording apparatus to record the content corresponding to a second configuration information of a reproducing apparatus to reproduce the content so that the reproducing apparatus supports the encoding method of the recorded content.
